(19) United States
(12) Patent Application Publication
(10) Pub. No.: US 2010/0286884 A1
(43) Pub. Date: Nov. 11, 2010

(54) VEHICLE SYSTEM

(76) Inventor: Jason Robert Bunn, Norfolk (GB)

Correspondence Address: Workman Nydegger;1000 Eagle Gate Tower, 60 East South Temple, Salt Lake City, UT, 84111, US

(21) Appl. No.: 12/741,563

(22) PCT Filed: Nov. 7, 2008
(86) PCT No.: PCT/GB08/51041

§ 371 Date: Jun. 22, 2010

(30) Foreign Application Priority Data
Nov. 8, 2007 (GB) 0721934.8

(51) Int. Cl. G06F 19/00; G08G 1/123

(52) U.S. Cl. 701/70; 340/988

(57) ABSTRACT

A vehicle system comprises: a detector for detecting the position and direction of a vehicle during its displacement; a database of mapping information; a database of gradient information; a display for presenting mapping information relevant to said vehicle's position and its anticipated displacement path; said display being configured to indicate the option of freewheeling; and a controller which, dependent upon the measured speed of said vehicle and predetermined gradient information for said anticipated displacement path, derives a signal indicative of the extent of freewheeling if said freewheeling option is taken.

### FIELD OF THE INVENTION

The invention relates to vehicle systems.

### BACKGROUND TO THE INVENTION

Self-propelled internal combustion vehicles such as the motorcar waste energy during its operation. Any improvement in efficiency of the use of the energy it consumes during its operation is of considerable significance given the increasing shortage of energy resource and the impact of consumption on the environment. One prior art energy saving system converts at least a portion of the braking energy into electricity employed for the powering of the forward motion in certain vehicles.

### SUMMARY OF THE INVENTION

In a first broad independent aspect, the invention provides a vehicle system comprising:

a detector for detecting the position and direction of a vehicle during its displacement;

a database of mapping information;

a database of gradient information;

a display for presenting mapping information relevant to said vehicle's position and its anticipated displacement path; said display being configured to indicate the option of freewheeling; and

a controller which, dependent upon the measured speed of said vehicle and predetermined gradient information for said anticipated displacement path, derives a signal indicative of the extent of freewheeling if said freewheeling option is taken.

In a subsidiary aspect, said controller automatically switches the vehicle between modes of operation dependent upon the reaching of a point of said displacement path.

In a further subsidiary aspect, the system further comprises a detector for detecting the presence of a gradient in a displacement path.

In a further subsidiary aspect, the system further comprises a detector for detecting the weight of the vehicle.

In a further subsidiary aspect, the system further comprises a user interface for selecting an option or entering data representative of the weight of the vehicle.

In a further subsidiary aspect, the system further comprises means for comparing the extent of freewheeling for a plurality of displacement paths.

In a further subsidiary aspect, the system further comprises means for calculating the likely fuel consumption for a plurality of displacement paths and for rating said paths dependent upon the likely fuel consumption values.

In a further subsidiary aspect, said controller operates in conjunction with an externally visible indicator for indicating to other drivers that a vehicle is in a freewheeling mode of operation.

In a further subsidiary aspect, said controller indicates the option of freewheeling at a variable point along the displacement path dependent upon measured speed of vehicle, weight of vehicle and one or more events in the displacement path.

In a further broad independent aspects, the invention provides a vehicle control system comprising a detector for detecting the position and direction of a vehicle during its displacement; and a controller for controlling a display of instructions to a driver; or for automatically controlling the operation of said vehicle dependent upon a predetermined event and/or upon the occurrence of an event in a displacement path; whereby the controller switches or allows the switching of the vehicle from a propelled mode of operation to a freewheeling mode of operation in which the vehicle pursues its displacement until the vehicle stops or the vehicle is switched or automatically switches back to a propelled mode of operation.

This configuration is particularly advantageous it reduces fuel consumption as it allows the vehicle to effectively coast towards a point on the displacement path such as traffic lights, roundabouts, bends, traffic jams, obstacles in a road without a driver having to solely rely on his/her vision. This system also reduces the mechanical wear and tear of the vehicle since less braking is required. Furthermore, it also improves the environmental impact of the vehicles during freewheeling since it minimises or does away altogether with engine noise. This system also has the added benefit of causing a reduction of speed when arriving towards a traffic slow point, which will improve road safety.

In a subsidiary aspect in accordance with one of the invention's broadest independent aspects, said controllers which switches or allows the switching of the vehicle between modes of operation dependent upon the predetermined proximity and/or the presence of a gradient in a displacement path. The configuration allows a driver to select freewheeling without the driver experiencing a reduction in performance. It also allows the driver to select his/her path dependent upon gradient and not only average achievable speed and distance for a particular path.

In a further subsidiary aspect, the system further comprises a detector for detecting the presence of a gradient in a displacement path. This would allow the system to operate with existing two dimensional global positioning mapping services whilst achieving the benefit of providing a driver and/or the controller with the information required to benefit from an energy saving mode of operation.

In a further subsidiary aspect, the system further comprises a detector for detecting the weight of the vehicle. This configuration is particularly advantageous because it allows the controller to adjust the point at which freewheeling would engage or the point at which the propelled mode of operation is reactivated.

In a further subsidiary aspect, the system further comprises means for inputting the weight of the vehicle and for selecting a displacement path. This configuration would allow the inputting of the controller to be more precise and for a driver to select a displacement path dependent upon potential saving which are obtainable from a given path selection.

In a further subsidiary aspect, the system further comprises means for calculating the likely fuel consumption for paths and for rating said paths dependent upon the likely fuel consumption they will use. This system marks a departure from the conventional systems, which provide the selection of paths on the basis of the likely time of transit rather than the environmental impact of the route selected.

In a further subsidiary aspect, said controller switches or allows the switching of the vehicle between modes of operation dependent upon the predetermined proximity and/or the occurrence of a junction in a displacement path. This configuration is particularly advantageous because it allows the frequent activation of the energy reducing system and therefore allows the maximisation of the energy saving over an extended period of time.

In a further subsidiary aspect, said controller indicates the option of freewheeling at a variable point along the displacement path dependent upon measured speed of vehicle, weight of vehicle and one or more events in the displacement path. This configuration is particularly advantageous because it allows the energy consumption to be tailored to a particular driver's profile and his or her vehicle.

### BRIEF DESCRIPTION OF THE FIGURES

FIG. 1 shows a flow diagram of a first embodiment of the invention.

FIG. 2 shows a flow diagram for a second embodiment of the invention.

FIG. 3 shows a flow diagram for a third embodiment of the invention.

### DETAILED DESCRIPTION OF THE FIGURES

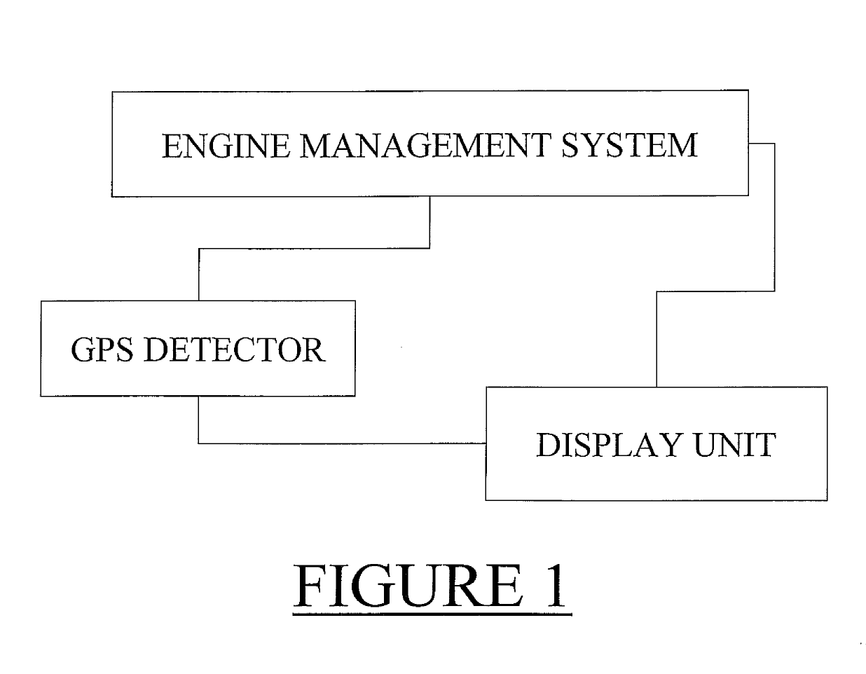

FIG. 1 shows the engine management system of a vehicle such as a motorcar. The invention may be applied to other types of vehicles such as air and sea going vehicles. Particular advantageous applications of the invention concern its application to domestic and industrial land going vehicles such as motorcars and trains. The engine management system controls the switching on and off of the engine and its operation throughout. It is envisaged that the energy management system may also control the extent, which the gears are engaged. The vehicle of the embodiment of FIG. 1 incorporates a global positioning system, which detects the position of the vehicle and its direction of travel. The GPS detector may be a separate portable device without any connection to an engine management system in any of the embodiments of the invention. The GPS detector is able to receive information remotely to cause information to be displayed relating to an opportunity for the driver to switch the operation of the vehicle from a propelled or internal propulsion mode of operation to a freewheeling mode operation. The conventional propelled mode of operation is when the motion generated by an internal combustion engine is transmitted to the wheels of a vehicle in order to drive its displacement.

The freewheeling mode of operation covers a mode of operation where the engine's power is preserved or simply switched off in order to reduce its consumption. In one freewheeling mode, the engine may be switched off for all purposes apart from supplying the necessary power for steering and for braking. In another freewheeling mode of operation, the gears are disengaged in the ordinary “neutral” position. In a particular freewheeling mode of operation, the control system may initially disengage the gears and then after a period of time or in certain conditions switch the engine off entirely.

In the embodiment of FIG. 1, the display unit may indicate to a driver that an opportunity exists to benefit from freewheeling. A button may be provided as part of the vehicle's controls, which may be actuated by a driver to switch from ordinary propelled mode of operation to a freewheeling mode of operation. Instead of a button, the vehicle's clutch and gear lever may be employed to that effect. The display unit may receive information to provide advanced warning to a driver when approaching traffic lights, roundabouts, bends, traffic jams or a particular downhill location in order to facilitate the optional switching of the driver from one mode of operation to the other.

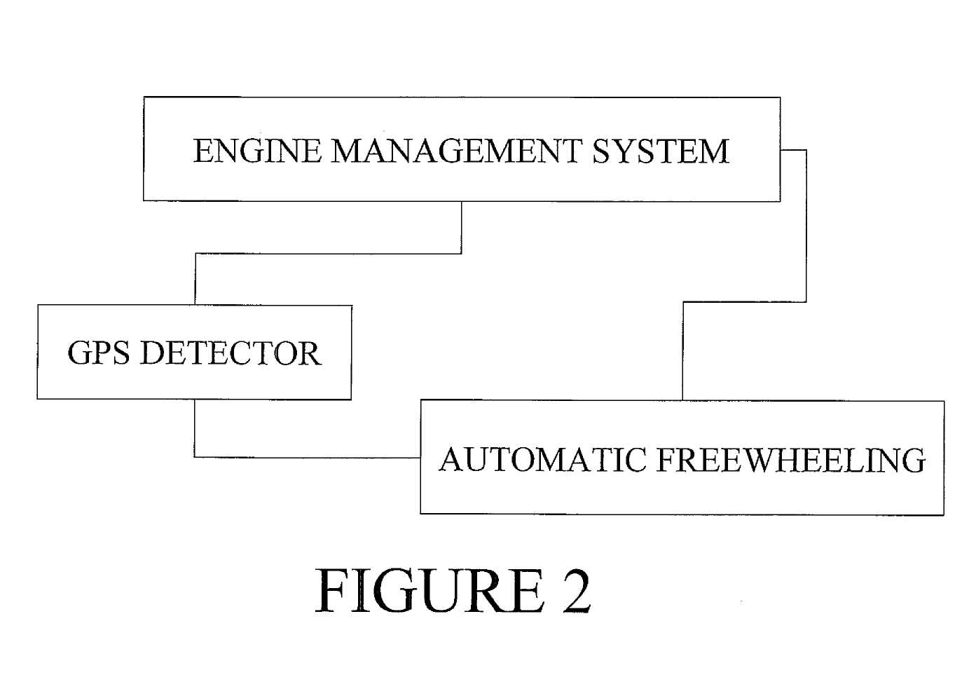

FIG. 2 shows an embodiment where the positional information of a vehicle is employed to automatically switch a vehicle into a freewheeling mode of operation. For example, as the vehicle is determined to be approaching the top of the hill, the engine management system would receive instructions from the GPS detector causing the automatic disengagement of the gears and/or the switching of the engine in order to allow the vehicle to rely on its initial momentum and gravity to continue on its path of displacement. The vehicle may also be equipped with indicators for sounding an alarm or displaying a visual alarm such as flashing lights to indicate for the benefit of other drivers that a particular vehicle is in a freewheeling mode. The light may for example be a green light, which would be one of a cluster of lights in for example the tailgate of a motorcar.

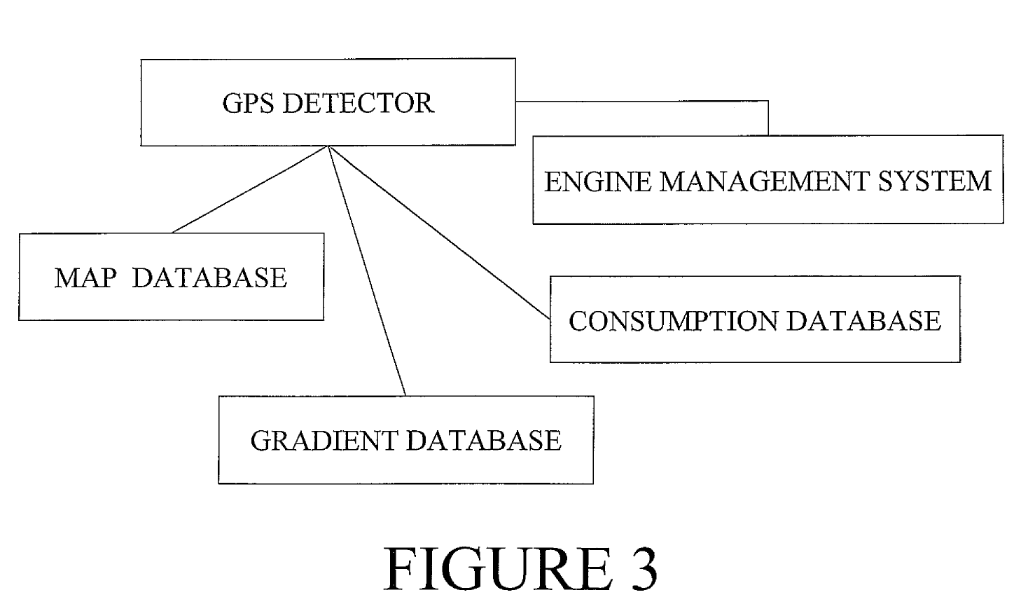

As show in FIG. 3, the GPS detector may receive positional data in the form of maps showing a vehicle. The maps may be continuously updated to display a vehicle's current position. The maps and gradient information may be stored locally on the GPS device or remotely. In addition, the GPS detector receives information from a gradient database, which has been built up from surveys in order to allow the control of the vehicle dependent upon the presence of a slope sufficient for practicing freewheeling. In addition, the GPS detector may also receive feeds relating to likely consumption values for a particular selected route. The GPS detector may also present alternative routes dependent upon likely fuel consumption in order to allow a driver to select his/her route dependent upon consumption rather than simply dependent upon distance and likely time of transit.

In addition, a vehicle is configured to incorporate optionally sensors in the suspension of the vehicle, for example, which are able to determine the load a particular vehicle is carrying. This will allow the calculation of when the switch from ordinary mode of operation to freewheeling ought to take place. This will allow the display inviting a driver to switch modes of operation to arrive at an optimum time point. It will also allow the switching between modes of operation to occur with great precision in the automatic freewheeling embodiment. In a similar fashion to switching from cruise control to ordinary driving mode, a vehicle may switch back from the freewheeling mode of operation to the powered mode of operation by simply pressing the accelerator. In addition, it is envisaged that the display may also indicate when a driver ought to engage a gear and which gear to engage.

The system may also calculate precisely when to cut out power so as to arrive at a point the driver would wish to stop with little or no breaking required at all.

Information with regards to the vehicle speed would be measured in order to further accurately predict when switching between modes of operation would be appropriate. The speed measurements may be obtained from the GPS device itself or be obtained from the engine management system. The distance of potential freewheeling may be obtained by looking up the gradient for a particular route, the measured speed and weight of vehicle in a look up table. Alternatively, approximate data may be obtained by simple physics equations which are known at the time of drafting this application.

The information gathered in terms of vehicle speed and weight and any other information may be stored either on board the vehicle or remotely. A GPS device may incorporate a touch screen to act as a user interface. Alternatively, it may respond to voice activation.

A database of typical vehicle weights may be accessed by the GPS unit. The user may select the appropriate vehicle from a list of vehicles. Additional weight information may be inputted into the system via an appropriate user interface which would allow the user to choose the level of load. The user may be able to choose from a variety of options such as luggage pieces, number of passengers, goods etc.

1. A vehicle system comprising:
a detector for detecting the position and direction of a vehicle during its displacement;
a database of mapping information;
a database of gradient information;
a display for presenting mapping information relevant to said vehicle's position and its anticipated displacement path; said display being configured to indicate the option of freewheeling; and
a controller which, dependent upon the measured speed of said vehicle and predetermined gradient information for said anticipated displacement path, derives a signal indicative of the extent of freewheeling if said freewheeling option is taken.

2. The system according to claim 1, wherein said controller automatically switches the vehicle between modes of operation dependent upon the reaching of a point of said displacement path.

3. The system according to claim 1, further comprising a detector for detecting the presence of a gradient in a displacement path.

4. The system according to claim 1, further comprising a detector for detecting the weight of the vehicle.

5. The system according to claim 1, further comprising a user interface for selecting an option or entering data representative of the weight of the vehicle.

6. The system according to claim 1, which is configured to compare the extent of freewheeling for a plurality of displacement paths.

7. The system according to claim 1, which is configured to calculate the likely fuel consumption for a plurality of displacement paths and for rating said paths dependent upon the likely fuel consumption values.

8. The system according to claim 1, wherein said controller operates in conjunction with an externally visible indicator for indicating to other drivers that a vehicle is in a freewheeling mode of operation.

9. The system according to claim 1, wherein said controller indicates the option of freewheeling at a variable point along the displacement path dependent upon measured speed of vehicle, weight of vehicle and at least one event in the displacement path.

10. (canceled)
